(19) United States
(12) Patent Application Publication
(10) Pub. No.: US 2026/0086838 A1
(43) Pub. Date: Mar. 26, 2026

(54) EFFICIENT PLACEMENT OF VIRTUALIZED INSTANCES WITH INTERGROUP AFFINITY AND ANTI-AFFINITY

(71) Applicant: International Business Machines Corporation, Armonk, NY (US)

(72) Inventors: Vaptistis Anogeianakis, Athens (GR); Irfan Ur Rehman, Aintree (AU)

(73) Assignee: International Business Machines Corporation, Armonk, NY (US)

(21) Appl. No.: 18/896,504

(22) Filed: Sep. 25, 2024

(51) Int. Cl. G06F 9/455; G06Q 30/0283; G06Q 30/04

(52) U.S. Cl. CPC G06F 9/45558; G06Q 30/0283; G06Q 30/04; G06F 2009/4557

(57) ABSTRACT

A data processing environment has a set of consumer pods and a set of provider nodes, and the set of consumers includes a first subset of a first group of consumers and a second subset of a second group of consumers. A pricing function in a solver component in the environment is configured with an intergroup affinity between the first subset and the second subset of consumers such that a member of the first subset of consumers gets placed on a selected provider from the set of providers when the selected provider already hosts a member of the second subset of consumers. The solver uses the intergroup affinity to cause a first placement of a first consumer from the first subset at a first provider from the set of providers, when the first provider already hosts a first consumer from the second subset of consumers.

### BACKGROUND

The present invention relates generally to the field of virtualized data processing environments. More particularly, the present invention relates to a method, system, and computer program for efficient placement of virtualized instances with intergroup affinity and anti-affinity as well as affinity between virtualized instances within a group and partitions of computing nodes on which they are placed.

A virtualized data processing environment refers to a computing setup where data processing tasks are performed in virtualized resources, such as virtual machines (VMs), containers, or virtual networks, rather than directly on physical hardware. Virtualization abstracts and decouples the hardware layer from the applications and data processing workloads, allowing multiple virtual environments to run concurrently on a single physical system or on a network of multiple physical systems.

A container in a virtual data processing environment is a lightweight, portable, and self-contained deployable unit that packages an application along with all of its dependencies, libraries, and configuration files. Unlike traditional virtual machines (VMs), containers share the host system's operating system kernel, making them more efficient and faster to start up. They provide isolation for applications, ensuring that they run consistently across different environments.

Kubernetes, often abbreviated as k8s, is an open-source platform for automating the deployment, scaling, and management of containerized applications. It orchestrates containers across a cluster of machines, ensuring that applications run consistently and efficiently. In a process known as container orchestration, Kubernetes manages the deployment and lifecycle of containerized applications. Containers (usually Docker containers) are packaged with everything they need to run (like code, libraries, and dependencies) and are deployed across a cluster of machines.

Kubernetes can automatically scale applications up or down based on demand. It can spin up more containers when traffic increases or scale down when traffic decreases. Kubernetes monitors the health of applications and automatically restarts failed containers or replaces unresponsive instances. Kubernetes distributes traffic across multiple instances of an application, ensuring that no single container is overwhelmed, improving performance and availability.

A Kubernetes cluster consists of multiple machines (nodes) that work together. A node is a worker machine in the Kubernetes cluster, which can be a physical server or a virtual machine. Each node runs pods and has its own operating system. A pod is the smallest deployable unit in Kubernetes. A pod typically contains one or more containers that are tightly coupled and share the same network and storage. Pods are ephemeral and are replaced if they fail.

A scheduler assigns pods to specific nodes based on resource availability and other constraints, such as affinity rules. Affinity generally is a preference that one thing should be associated with a specific other thing. Affinity in the presently available virtual marketplace conceptualization of k8s architecture is a constraint that commodity trade in the virtual marketplace of deployment commodities represent only that certain pods should be deployed on certain nodes only-in other words, the commodity trade only represents a singular-pod-to-a-singular-node affinity. Conversely, anti-affinity is a preference that one thing should not be associated with a specific other thing. Anti-affinity in the presently available k8s architecture is a constraint that certain pods should not be deployed with certain other pods of the same group in other words, a pod-to-pod anti-affinity within a defined group of pods (intragroup anti-affinity).

In Kubernetes, keys and labels are identifiers or codes used to organize, categorize, and manage resources within a cluster. They allow users to define metadata and group objects (like pods, nodes, and services) for easier identification, filtering, and management. A label is a key-value pair that is attached to Kubernetes objects (such as pods, services, nodes, or deployments) to provide metadata. Labels allow users to organize and select subsets of objects based on specific criteria. A label consists of a key and a value. For example, environment=production is a label where environment is the key and production is the value. Objects can have multiple labels, providing flexible ways to organize resources. For example, a pod can be labeled with app=frontend, environment=production, and tier=web. A key is the identifier part of a label. It helps define what the label represents, such as app, environment, or tier.

### SUMMARY

The illustrative embodiments provide for efficient placement of virtualized instances with intergroup affinity and anti-affinity. An embodiment includes configuring, in a solver component in a data processing environment comprising a set of consumer pods (consumers) and a set of provider nodes (providers), a pricing function, wherein the set of consumers comprises a first subset of a first group of consumers and a second subset of a second group of consumers; the embodiment further includes further configuring, in the pricing function an intergroup affinity between the first subset and the second subset of consumers; the embodiment further includes configuring the intergroup affinity such that a member of the first subset of consumers gets placed on a selected provider from the set of providers when the selected provider already hosts a member of the second subset of consumers; and the embodiment further includes causing, by the solver component responsive to the configuring of the intergroup affinity, a first placement of a first consumer from the first subset at a first provider from the set of providers, the first provider already hosting a first consumer from the second subset of consumers.

Other embodiments of this aspect include corresponding computer systems, apparatus, and computer programs recorded on one or more computer storage devices, each configured to perform the actions of the embodiment.

An embodiment includes a computer-usable program product. The computer-usable program product includes a computer-readable storage medium and program instructions stored on the storage medium.

An embodiment includes a computer system. The computer system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts a block diagram of a computing environment in accordance with an illustrative embodiment;

FIG. 2 depicts a block diagram of an example configuration in which an embodiment for efficient placement of virtualized instances with intergroup affinity and anti-affinity can be implemented;

FIG. 3 depicts a configuration for efficient placement of virtualized instances with intergroup affinity and anti-affinity in accordance with an illustrative embodiment;

FIG. 4A depicts a step in a placement operation with an intergroup affinity constraint in accordance with an illustrative embodiment;

FIG. 4B depicts another step in a placement operation with an intergroup affinity constraint in accordance with an illustrative embodiment;

FIG. 4C depicts another step in a placement operation with an intergroup affinity constraint in accordance with an illustrative embodiment;

FIG. 4D depicts another step in a placement operation with an intergroup affinity constraint in accordance with an illustrative embodiment;

FIG. 4E depicts another step in a placement operation with an intergroup affinity constraint in accordance with an illustrative embodiment;

FIG. 4F depicts another step in a placement operation with an intergroup affinity constraint in accordance with an illustrative embodiment;

FIG. 4G depicts another step in a placement operation with an intergroup affinity constraint in accordance with an illustrative embodiment;

FIG. 4H depicts a placement operation with an intergroup affinity constraint relative to partitions of providers in accordance with an illustrative embodiment;

FIG. 5 depicts a configuration for efficient placement of virtualized instances with intergroup affinity and anti-affinity in accordance with an illustrative embodiment;

FIG. 6A depicts a step in a placement operation with an intergroup anti-affinity constraint in accordance with an illustrative embodiment;

FIG. 6B depicts another step in a placement operation with an intergroup anti-affinity constraint in accordance with an illustrative embodiment;

FIG. 6C depicts another step in a placement operation with an intergroup anti-affinity constraint in accordance with an illustrative embodiment;

FIG. 6D depicts another step in a placement operation with an intergroup anti-affinity constraint in accordance with an illustrative embodiment;

FIG. 6E depicts another step in a placement operation with an intergroup anti-affinity constraint in accordance with an illustrative embodiment;

FIG. 6F depicts another step in a placement operation with an intergroup anti-affinity constraint in accordance with an illustrative embodiment; and

FIG. 6G depicts a placement operation with an intergroup anti-affinity constraint relative to partitions of providers in accordance with an illustrative embodiment.

### DETAILED DESCRIPTION

The illustrative embodiments are described using k8s as a nonlimiting example architecture for virtualized data processing environments due to the popularity and ubiquitousness of k8s. Those of ordinary skill in the art will appreciate that an embodiment described herein can be applied in a similar manner to other non-k8s data processing environments where a similar placement problem has to be solved. Adaptations of the illustrative embodiments to other non-k8s environments is contemplated within the scope of the illustrative embodiments.

By similar reasoning, references to pods are only used for the clarity of the description and not intended to be limited to k8s pods but to similarly purposed deployable units of other kinds in other types of virtualized data processing environments. Generally, the term “consumer” is used herein to refer to pods and pod-like units. Similarly, references to nodes are only used for the clarity of the description and not intended to be limited to k8s nodes but to similarly purposed host systems of other kinds in other types of virtualized data processing environments. Generally, the term “provider” is used herein to refer to nodes and node-like systems.

The illustrative embodiments recognize that there are deployment situations where an improved method for ensuring efficient accommodation of affinity between different groups of consumers (intergroup affinity) in a virtualized data processing environment would be advantageous. The illustrative embodiments further recognize that an improved method for efficient accommodation of affinity between a group of consumers and a group of providers (provider partition affinity) in a virtualized data processing environment would be advantageous. A group of providers is referred to hereinafter as a partition of providers.

The illustrative embodiments recognize that there are deployment situations where an improved method for ensuring efficient accommodation of anti-affinity between different groups of consumers (intergroup anti-affinity) in a virtualized data processing environment would be advantageous. The illustrative embodiments further recognize that an improved method for ensuring efficient accommodation of anti-affinity between a group of consumers and a partition of providers (provider partition anti-affinity) in a virtualized data processing environment would be advantageous.

Only for the clarity of the description and without implying any limitation thereto, the illustrative embodiments are described using a simplified k8s architecture with a limited number of nodes and pods as consumers and providers. Many layers, components, functions, and operations of the k8s architecture are therefore intentionally omitted for simplification of the environment within which the novel aspects of the illustrative embodiments can be represented and described with better clarity.

A pod generally needs computing resources from a node to operate. More specifically, a pod needs specific types and quantities of specific resources from the node in order to operate in a desirable manner on the node. A presently available solver architecture can be represented as a virtual marketplace in which the providers (nodes) commoditize the computing resources they have available to offer to pods, and consumers (pods) shop for said commodities. Thus, in this architecture, providers can be seen as selling commodities in their inventory, and consumers can be seen as buying the commodities on their shopping list of commodities.

Under such an arrangement, presently, the providers use the labels and keys mechanism to represent the types and quantities of various commodities. An intermediary in the architecture (referred to herein as a “solver”) matches consumers with providers where the provider is able to sell the commodities that a consumer is looking to buy in sufficient quantities. The illustrative embodiments recognize that in a k8s system of any meaningful size, the operation of the solver can itself become computationally intensive and can divert a significant amount of computing resources for solver operations that could otherwise be used for processing other revenue workloads.

The illustrative embodiments extend the concept of commodities in a novel way to represent non-computational resources. The illustrative embodiments further extend the manner of trading the new commodities in a novel way—as different from the presently used manner of trading existing computational commodities. The illustrative embodiments further enable the novel commodity types and the novel manner of trading the same in a manner that minimizes the solver's computational load in performing these transactions.

In one embodiment, a group of pods is represented as a new commodity in the nodes. Specifically, an improved provider according to an embodiment is equipped with a commodity that represents a group of consumer (“group-commodity”), and the provider has some quantities of each of one or more group-commodity to sell to consumers. An improved consumer according to an embodiment has associated therewith a group, and when looking for deployment in the architecture, wants to buy a certain quantity of the group-commodity. Specifically, this “group” aspect of a consumer is usable for establishing the consumer's affinity or anti-affinity with consumers of other groups as well as provider partitions, in accordance with the various embodiments described herein.

An improved solver according to an embodiment implements a novel pricing function (also interchangeably referred to herein as a price function) for quickly and efficiently evaluating a supply and demand for group-commodities. The improved solver uses this pricing function to determine using a simple arithmetic computation—which incurs minimal compute cost—whether a demand for group-commodity from a consumer of a first group can be supplied by a particular provider without violating an intergroup affinity constraint of consumers of the first group with a consumer of a second group. In one example, suppose that there are two groups of consumers—a first group of group 0 (0-consumer) and a second group of group 1 (1-consumer). An intergroup affinity relationship is defined such that a 0-consumer can only go on a provider where at least one 1-consumer is present. Correspondingly, a provider maintains an inventory of group-commodity of only group 1. In other words, a provider in this example system can sell only group 1 group-commodity and keeps a count of how many group 1 group-commodity it has presently sold, i.e., how many consumer pods of group 1 are presently on that provider node.

The improved solver implements the pricing function for intergroup affinity as follows—(i) the price for placing a group 0 consumer at a particular provider is high (above an upper threshold) if the provider has not sold any group 1 group-commodity (i.e., the provider has no group 1 consumer placed on the provider yet); (ii) the price for placing a group 0 consumer at a particular provider is low (below a lower threshold) if the provider has sold any group 1 group-commodity (i.e., the provider has at least one group 1 consumer placed on the provider); and (iii) the price for placing a group 0 consumer at a particular provider is medium (between and including the lower threshold and the upper threshold) if the provider has sold at least one group 1 group-commodity and has some combination of two or more consumers of any group on the provider (i.e., the provider has two or more consumers with at least one group 1 consumer placed on the provider, with the actual medium value of the price being a function of the number of consumers on the provider, provider resources consumed by the other consumers, or a combination thereof).

As an example to illustrate the operation, suppose a group 0 consumer presents a demand for a group-commodity. Upon such demand, the solver checks the count of group 1 group-commodity that a provider has sold (the provider keeps a count of group 1 group-commodity sold) and a total number of consumers on the provider currently. Using these two values, the solver performs the computation of the pricing function to determine whether the price to place the group 0 consumer of that provider is high, low, or medium.

In one embodiment, the solver checks the price for all available providers, selects the provider with the lowest cost, and places the group 0 consumer on the lowest cost provider. In another embodiment, the solver starts checking the price with each available provider until the price for a provider computes to a low price; the solver stops further price shopping with the remaining providers and places the group 0 consumer with the first provider whose price computes as low.

Generally, a group 1 consumer can be placed anywhere. However, in one embodiment, the solver tries to apply the pricing function in the placement of group 1 consumer as well and places where the price of placement is the lowest according to the pricing function. For example, - (i) the price for placing a group 1 consumer at a particular provider is high (above an upper threshold) if the provider has no compute commodities remaining or has oversold the compute commodities already; (ii) the price for placing a group 1 consumer at a particular provider is low (below a lower threshold) or even immaterial (not requiring consideration) if the provider has not sold any group 1 group-commodity yet (i.e., the provider has no group 1 consumer and therefore no group 0 consumers either); and (iii) the price for placing a group 1 consumer at a particular provider is medium (between and including the lower threshold and the upper threshold) if the provider has sold at least one group 1 group-commodity and has some combination of two or more consumers of any group on the provider (i.e., the provider has two or more consumers with at least one group 1 consumer placed on the provider, with the actual medium value of the price being a function of the number of consumers on the provider).

In one embodiment, the solver checks the price for all available providers, selects the provider with the lowest cost, and places the group 1 consumer on the lowest cost provider. In another embodiment, the solver starts checking the price with each available provider until the price for a provider computes to a low price; the solver stops further price shopping with the remaining providers and places the group 1 consumer with the first provider whose price computes as low.

The above operation describes an example using 1-1 unidirectional intergroup affinity. An affinity is unidirectional when one group is constrained by the affinity to the other group but the other group is not constrained by the affinity. From this disclosure, those of ordinary skill in the art will be able to implement an embodiment for a plurality of such intergroup affinities between plurality of groups of consumers, in either direction of the affinity. Such implementations are contemplated within the scope of the illustrative embodiments.

Furthermore, the above operation describes the intergroup affinity based placement of a consumer on a single provider. The operation can be extended to a partition of providers in a similar manner within the scope of the illustrative embodiments.

For example, one embodiment creates a partition of providers, e.g., a node group that implements some manner of pooling of the compute commodities of the underlying individual member nodes and their compute infrastructure for the purposes of pods placements on the member nodes. According to the embodiment, a partition maintains an inventory of group-commodity of only group 1. In other words, a partition in this example system can sell only group 1 group-commodity and keeps a count of how many group 1 group-commodity it has presently sold, i.e., how many total consumer pods of group 1 are presently on all provider nodes of that partition, considered collectively.

The improved solver implements the pricing function for intergroup affinity as follows—(i) the price for placing a group 0 consumer at a particular partition is high (above an upper threshold) if the partition has not sold any group 1 group-commodity (i.e., the partition has no group 1 consumer placed on the partition yet); (ii) the price for placing a group 0 consumer at a particular partition is low (below a lower threshold) if the partition has sold any group 1 group-commodity (i.e., the partition has at least one group 1 consumer placed on the partition); and (iii) the price for placing a group 0 consumer at a particular partition is medium (between and including the lower threshold and the upper threshold) if the partition has sold at least one group 1 group-commodity and has some combination of two or more consumers of any group on the partition (i.e., the partition has two or more consumers with at least one group 1 consumer placed on the partition, with the actual medium value of the price being a function of the number of consumers on the partition).

As an example to illustrate the operation, suppose a group 0 consumer presents a demand for a group-commodity. Upon such demand, the solver checks the count of group 1 group-commodity that a partition has sold (the partition keeps a count of group 1 group-commodity sold) and a total number of consumers on the partition currently. Using these two values, the solver performs the computation of the pricing function to determine whether the price to place the group 0 consumer of that partition is high, low, or medium.

In one embodiment, the solver checks the price for all available partitions, selects the partition with the lowest cost, and places the group 0 consumer on the lowest cost node in the lowest cost partition. In another embodiment, the solver starts checking the price with each available partition until the price for a partition computes to a low price; the solver stops further price shopping with the remaining partitions and places the group 0 consumer on the lowest cost node in the first partition whose price computes as low.

Generally, a group 1 consumer can be placed anywhere. However, in one embodiment, the solver tries to apply the pricing function in the placement of group 1 consumer as well and places where the price of placement is the lowest according to the pricing function. For example,—(i) the price for placing a group 1 consumer at a particular partition is high (above an upper threshold) if the partition has no compute commodities remaining or has oversold the compute commodities already; (ii) the price for placing a group 1 consumer at a particular partition is low (below a lower threshold) if the partition has not sold any group 1 group-commodity yet (i.e., the partition has no group 1 consumer and therefore no group 0 consumers either); and (iii) the price for placing a group 1 consumer at a particular partition is medium (between and including the lower threshold and the upper threshold) if the partition has sold at least one group 1 group-commodity and has some combination of two or more consumers of any group on the partition (i.e., the partition has two or more consumers with at least one group 1 consumer placed on the partition, with the actual medium value of the price being a function of the number of consumers on the partition).

In one embodiment, the solver checks the price for all available partitions, selects the partition with the lowest cost, and places the group 1 consumer on the lowest cost partition. In another embodiment, the solver starts checking the price with each available partition until the price for a partition computes to a low price; the solver stops further price shopping with the remaining partitions and places the group 1 consumer with the first partition whose price computes as low.

An improved solver according to an embodiment implements a novel pricing function (also interchangeably referred to herein as a price function) for quickly and efficiently evaluating a supply and demand for group-commodities in an intergroup anti-affinity with single providers and intergroup anti-affinity with partitions of providers. The improved solver uses this pricing function to determine using a simple arithmetic computation—which incurs minimal compute cost—whether a demand for group-commodity from a consumer of a first group can be supplied by a particular provider without violating an intergroup anti-affinity constraint of consumers of the first group with a consumer of a second group. In one example, suppose that there are two groups of consumers—a first group of group 0 (0-consumer) and a second group of group 1 (1-consumer). An intergroup anti-affinity relationship is defined such that a 0-consumer cannot go on a provider where at least one 1-consumer is present. Correspondingly, a provider maintains an inventory of group-commodity of group 0 and group 1. In other words, a provider in this example system can sell a group 0 or group 1 group-commodity and keeps a count of how many of each group of group-commodity it has presently sold, i.e., how many consumer pods of either group are presently on that provider node.

The improved solver implements the pricing function for intergroup affinity as follows—(i) the price for placing a group 0 consumer at a particular provider is high (above an upper threshold) if the provider has sold any group 1 group-commodity (i.e., the provider has at least one group 1 consumer placed on the provider), and vice versa—i.e., the price for placing a group 1 consumer at a particular provider is high (above an upper threshold) if the provider has sold any group 0 group-commodity (i.e., the provider has at least one group 0 consumer placed on the provider); (ii) the price for placing a group 0 consumer at a particular provider is low (below a lower threshold) if the provider has not sold any group 1 group-commodity (i.e., the provider has no one group 1 consumer placed on the provider yet), and vice versa—i.e., the price for placing a group 1 consumer at a particular provider is low (below a lower threshold) if the provider has not sold any group 0 group-commodity (i.e., the provider has no one group 0 consumer placed on the provider yet); and (iii) the price for placing a group 0 consumer at a particular provider is medium (between and including the lower threshold and the upper threshold) if the provider has sold at least one group 0 group-commodity and has some number of group 0 consumers on the provider (i.e., the provider has one or more consumers of group 0 placed on the provider, with the actual medium value of the price being a function of the number of consumers on the provider), and similarly-the price for placing a group 1 consumer at a particular provider is medium (between and including the lower threshold and the upper threshold) if the provider has sold at least one group 1 group-commodity and has some number of group 1 consumers on the provider (i.e., the provider has one or more consumers of group 1 placed on the provider, with the actual medium value of the price being a function of the number of consumers on the provider).

As an example to illustrate the operation, suppose a group 0 consumer presents a demand for a group-commodity. Upon such demand, the solver checks the count of group 1 group-commodity that a provider has sold (the provider keeps a count of both groups of group-commodity sold) and a total number of consumers on the provider currently. Using these two values, the solver performs the computation of the pricing function to determine whether the price to place the group 0 consumer of that provider is high, low, or medium.

In one embodiment, the solver checks the price for all available providers, selects the provider with the lowest cost, and places the group 0 consumer on the lowest cost provider. In another embodiment, the solver starts checking the price with each available provider until the price for a provider computes to a low price; the solver stops further price shopping with the remaining providers and places the group 0 consumer with the first provider whose price computes as low.

Similarly, in another example, the solver tries to apply the pricing function in the placement of group 1 consumer as well, and places where the price of placement is the lowest according to the pricing function. In one embodiment, the solver checks the price for all available providers, selects the provider with the lowest cost, and places the group 1 consumer on the lowest cost provider. In another embodiment, the solver starts checking the price with each available provider until the price for a provider computes to a low price; the solver stops further price shopping with the remaining providers and places the group 1 consumer with the first provider whose price computes as low.

The above operation describes an example using 1-1 bidirectional intergroup anti-affinity. An anti-affinity is bidirectional when each group in a pair is constrained by anti-affinity to the other group in the pair. From this disclosure, those of ordinary skill in the art will be able to implement an embodiment for a plurality of such intergroup anti-affinities between plurality of groups of consumers, in either direction of the anti-affinity. Such implementations are contemplated within the scope of the illustrative embodiments.

Furthermore, the above operation describes the intergroup anti-affinity based placement of a consumer on a single provider. The operation can be extended to a partition of providers in a similar manner within the scope of the illustrative embodiments.

For example, one embodiment creates a partition of providers, e.g., a node group that implements some manner of pooling of the compute commodities of the underlying individual member nodes and their compute infrastructure for the purposes of pods placements on the member nodes. According to the embodiment, a partition maintains an inventory of group-commodity of group 0 and group 1. In other words, a partition in this example system can sell a group 0 or group 1 group-commodity and keeps a count of how many of each group of group-commodity it has presently sold, i.e., how many consumer pods of either group are presently on all provider nodes of that partition considered together.

An improved solver according to an embodiment implements a novel pricing function (also interchangeably referred to herein as a price function) for quickly and efficiently evaluating a supply and demand for group-commodities in an intergroup anti-affinity with single providers and intergroup anti-affinity with partitions of providers. The improved solver uses this pricing function to determine using a simple arithmetic computation—which incurs minimal compute cost—whether a demand for group-commodity from a consumer of a first group can be supplied by a particular partition without violating an intergroup anti-affinity constraint of consumers of the first group with a consumer of a second group. In one example, suppose that there are two groups of consumers—a first group of group 0 (0-consumer) and a second group of group 1 (1-consumer). An intergroup affinity relationship is defined such that a 0-consumer cannot go on a partition where at least one 1-consumer is present. Correspondingly, a partition maintains an inventory of group-commodity of group 0 and group 1. In other words, a partition in this example system can sell a group 0 or group 1 group-commodity and keeps a count of how many of each group of group-commodity it has presently sold, i.e., how many consumer pods of either group are presently on that partition.

The improved solver implements the pricing function for intergroup affinity as follows—(i) the price for placing a group 0 consumer at a particular partition is high (above an upper threshold) if the partition has sold any group 1 group-commodity (i.e., the partition has at least one group 1 consumer placed on the partition), and vice versa—i.e., the price for placing a group 1 consumer at a particular partition is high (above an upper threshold) if the partition has sold any group 0 group-commodity (i.e., the partition has at least one group 0 consumer placed on the partition); (ii) the price for placing a group 0 consumer at a particular partition is low (below a lower threshold) if the partition has not sold any group 1 group-commodity (i.e., the partition has no one group 1 consumer placed on the provider yet), and vice versa—i.e., the price for placing a group 1 consumer at a particular partition is low (below a lower threshold) if the partition has not sold any group 0 group-commodity (i.e., the partition has no one group 0 consumer placed on the partition yet); and (iii) the price for placing a group 0 consumer at a particular partition is medium (between and including the lower threshold and the upper threshold) if the partition has sold at least one group 0 group-commodity and has some number of group 0 consumers on the partition (i.e., the partition has one or more consumers of group 0 placed on the partition, with the actual medium value of the price being a function of the number of consumers on the partition), and similarly-the price for placing a group 1 consumer at a particular partition is medium (between and including the lower threshold and the upper threshold) if the partition has sold at least one group 1 group-commodity and has some number of group 1 consumers on the partition (i.e., the partition has one or more consumers of group 1 placed on the partition, with the actual medium value of the price being a function of the number of consumers on the partition).

As an example to illustrate the operation, suppose a group 0 consumer presents a demand for a group-commodity. Upon such demand, the solver checks the count of group 1 group-commodity that a partition has sold (the partition keeps a count of both groups of group-commodity sold) and a total number of consumers on the partition currently. Using these two values, the solver performs the computation of the pricing function to determine whether the price to place the group 0 consumer of that partition is high, low, or medium.

In one embodiment, the solver checks the price for all available partitions, selects the partition with the lowest cost, and places the group 0 consumer on the lowest cost partition. In another embodiment, the solver starts checking the price with each available partition until the price for a partition computes to a low price; the solver stops further price shopping with the remaining partitions and places the group 0 consumer with the first partition whose price computes as low.

Similarly, in another example, the solver tries to apply the pricing function in the placement of group 1 consumer as well, and places where the price of placement is the lowest according to the pricing function. In one embodiment, the solver checks the price for all available partitions, selects the partition with the lowest cost, and places the group 1 consumer on the lowest cost partition. In another embodiment, the solver starts checking the price with each available partition until the price for a partition computes to a low price; the solver stops further price shopping with the remaining partitions and places the group 1 consumer with the first partition whose price computes as low.

The above operation describes an example using 1-1 bidirectional intergroup anti-affinity in the context of partitions of providers. An affinity is bidirectional when each group in a pair is constrained by anti-affinity to the other group in the pair. From this disclosure, those of ordinary skill in the art will be able to implement an embodiment for a plurality of such intergroup anti-affinities between plurality of groups of consumers, in either direction of the anti-affinity. Such implementations are contemplated within the scope of the illustrative embodiments.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting on the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, computer readable storage media, high-level features, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again, depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

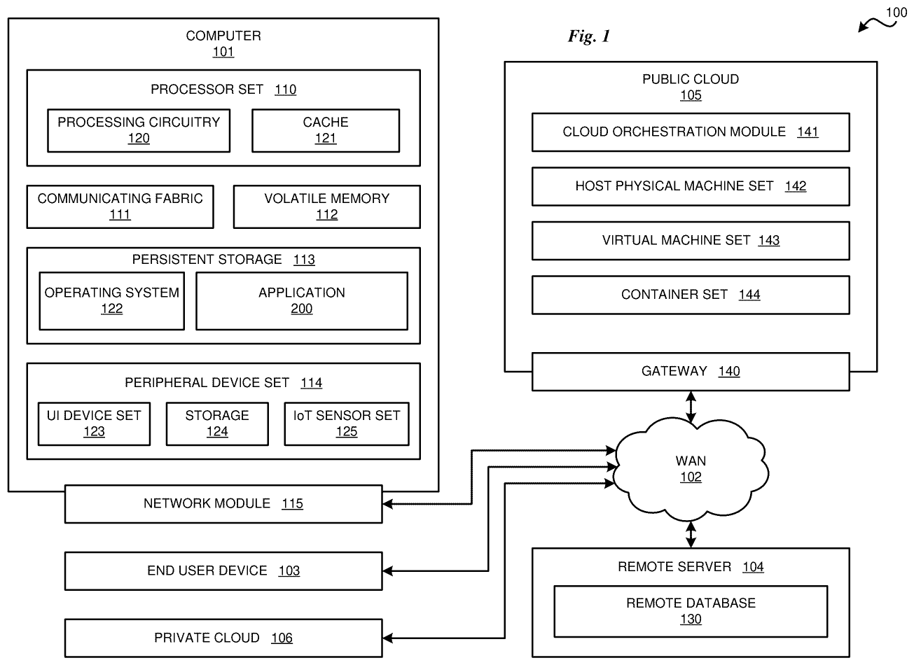

With reference to FIG. 1, this figure depicts a block diagram of a computing environment 100. Computing environment 100 contains an example of an environment for the execution of at least some of the computer code involved in performing the inventive methods, such as application 200 that implements one or more embodiments for efficient placement of virtualized instances with intergroup affinity and anti-affinity as described herein. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

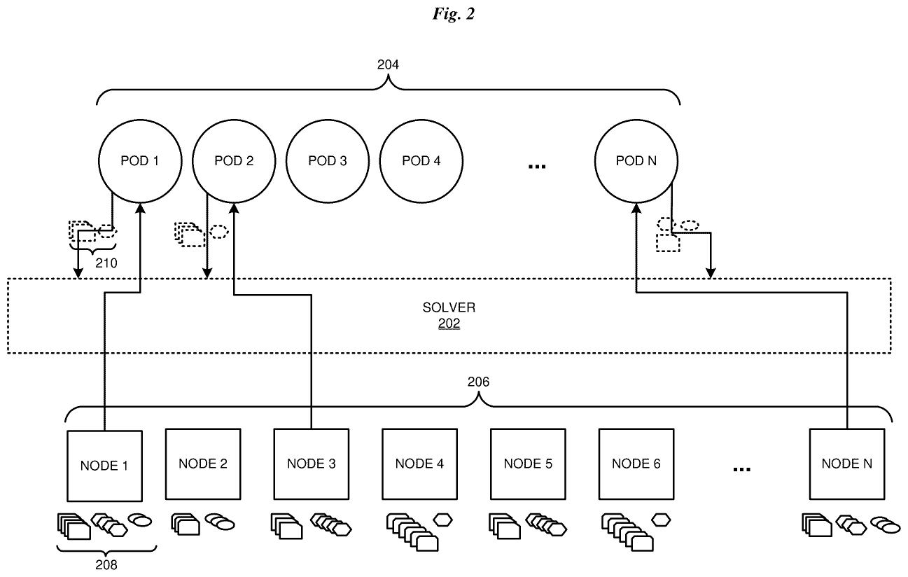

With reference to FIG. 2, this figure depicts a block diagram of an example configuration in which an embodiment for efficient placement of virtualized instances with intergroup affinity and anti-affinity can be implemented. In this simplified configuration for k8s, application 202 functions as a solver, pods 204 are simplified examples of consumers, and nodes 206 are simplified examples of providers. A provider, such as Node 1 provides a number (whole or a portion thereof) of commodities 208 of one or more types, a type of commodity representing a type of computing resource and a number of a particular type of commodity representing an amount of that computing resource available at Node 1. Other nodes are configured and represented in a similar manner.

A consumer, such as Pod 1, requests a number of commodities 210 of one or more types, a type of commodity in the request representing a type of computing resource Pod 1 needs and a number of a particular type of commodity representing an amount of that computing resource requested by Pod 1. Other pods are configured and represented in a similar manner.

Solver 202 resolves a pod's request to a specific node as shown. For example, Node 1 provides the requested commodities to Pod 1 and updates the count of corresponding commodities remaining available at Node 1. Node 3 similarly fulfills Pod 2's request and hosts Pod 2. Node n similarly fulfills Pod n's request and hosts Pod n. The representation of a commodity and its numerosity is chosen and depicted arbitrarily for illustration purposes, and may represent any resource available at or to a node in a given implementation.

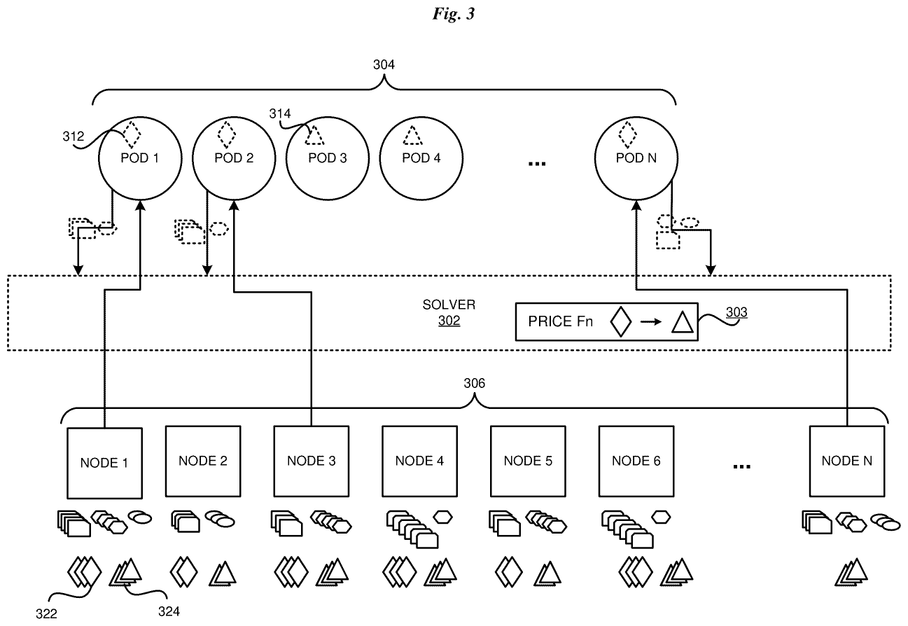

With reference to FIG. 3, this figure depicts a configuration for efficient placement of virtualized instances with intergroup affinity and anti-affinity in accordance with an illustrative embodiment. Application 302 is an example of application 200 in FIG. 1. Application 302 is an improved solver as described herein, implementing one or more pricing functions according to one or more embodiments described herein. In the depiction of FIG. 3, solver 302 implements an intergroup affinity pricing function 303 as described herein.

Pods 304, identified as Pod 1, Pod 2, Pod 3, Pod 4, . . . , Pod n, represent a plurality of improved consumers as described herein. Nodes 306, identified as Node 1, Node 2, Node 3, Node 4, Node 5, Node 6, . . . , Node n, represent a plurality of improved providers as described herein.

For example, each of pods 304 implements a way of requesting, or buying, a group-commodity corresponding to a consumer group associated with the pod. Different shapes of group-commodities represent different groups and are selected arbitrarily for illustration purposes. For example, Pod 1 is of group 312, illustrated as a diamond shape, and Pod 3 is of group 314, illustrated as a triangle shape. Similarly, each of nodes 306 implements a group-commodity corresponding to a group or consumer group associated with the pods and the node maintains a quantity of the group-commodities of one or more groups that it can allocate, or sell, in response to a request from a pod. For example, Node 1 is shown to maintain a certain quantity 322 of group-commodity of group 312, and a certain quantity 324 of group-commodity of group 314. Other nodes in nodes 306 are similarly configured.

Although the pricing function is depicted as one group (diamond)-to-one group (triangle), many group affinities can be handled by a single pricing function in this manner. Different group-pairs can, but need not utilize separate pricing functions. In many cases, employing one pricing function for multiple group affinities might be computationally advantageous and is contemplated within the scope of the illustrative embodiments. Similarly, although pods of group 312 are depicted as buying diamond commodities and pods of group 314 as buying triangle commodities, many group affinities can be handled by making both groups of pods buying the same shape of commodity, but different amounts. e.g. group 312 could be buying 0 diamonds and group 314 could be buying 1 diamonds. In many cases, employing one commodity shape but different quantities might be computationally advantageous and is contemplated within the scope of this illustrative embodiments.

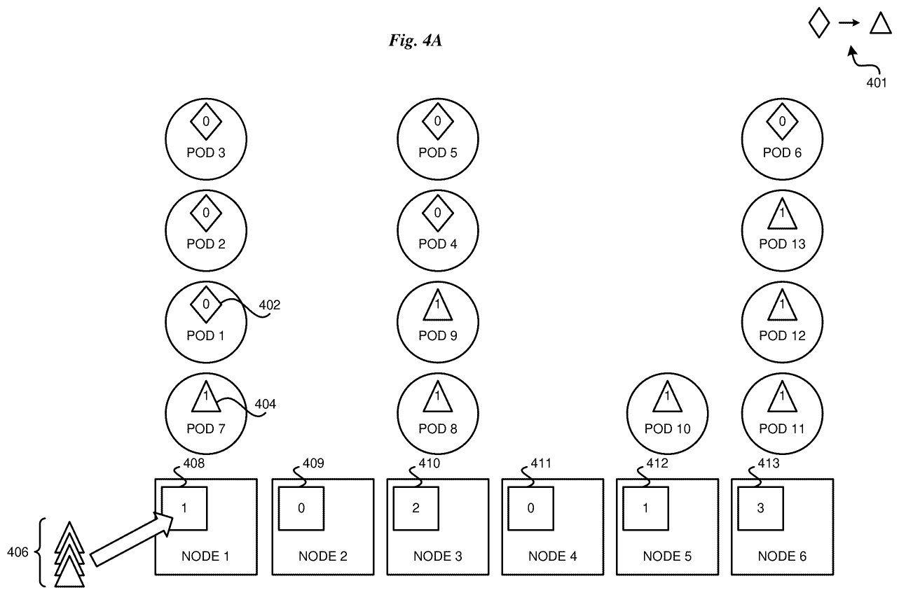

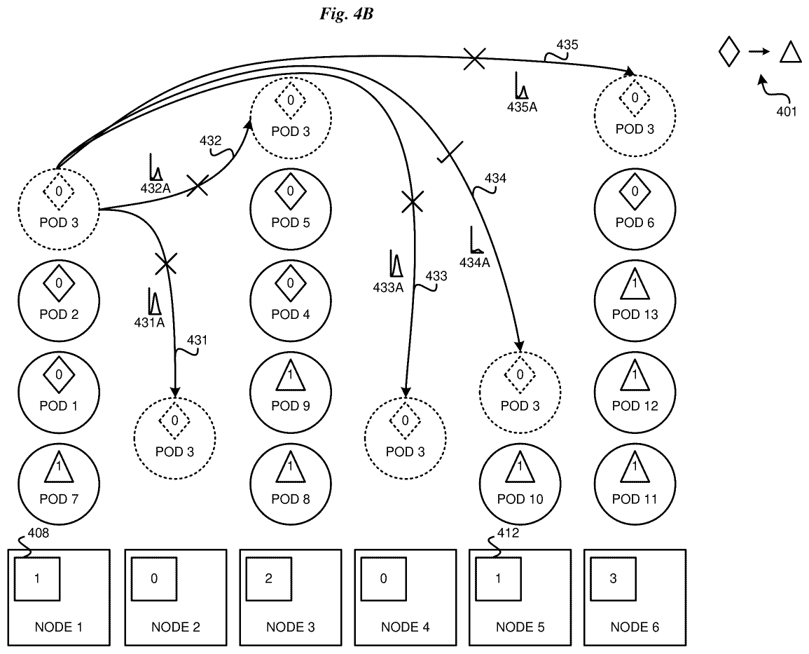

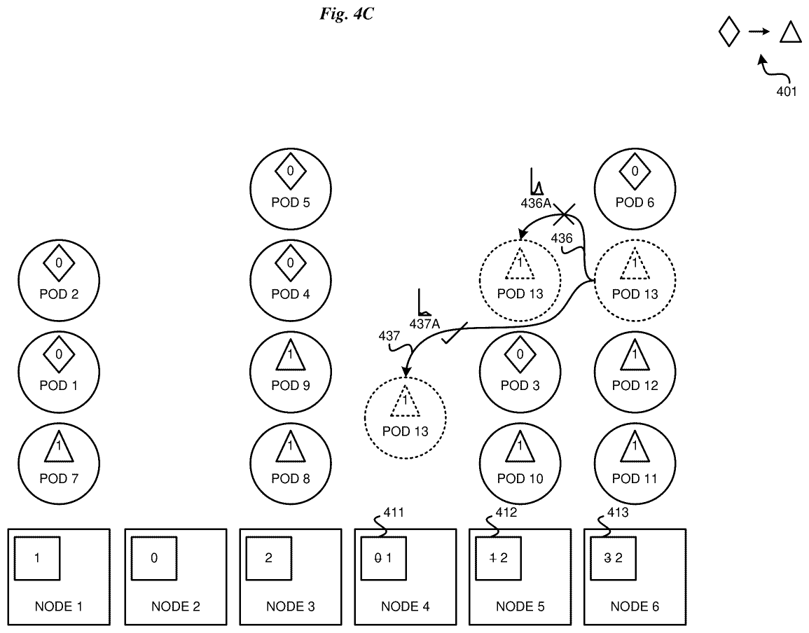

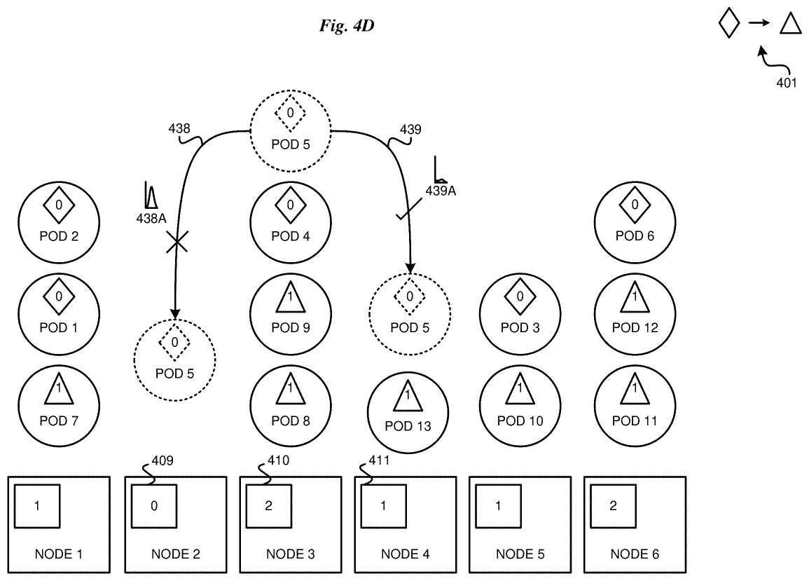

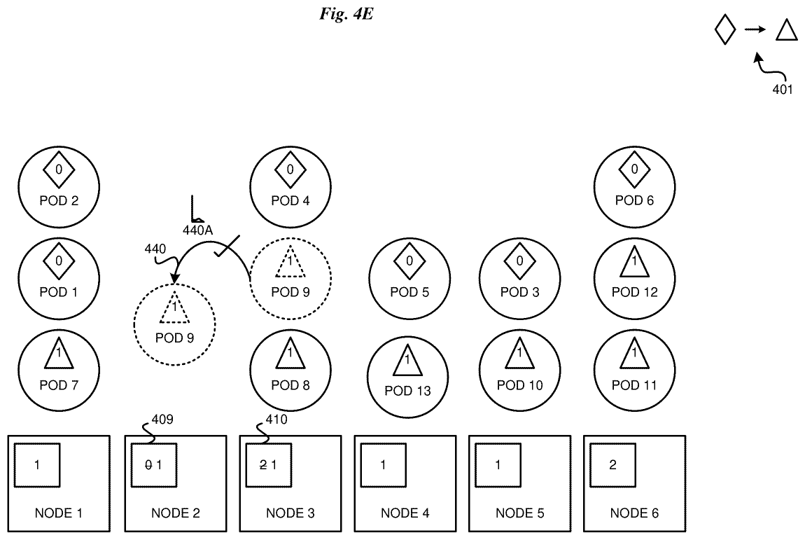

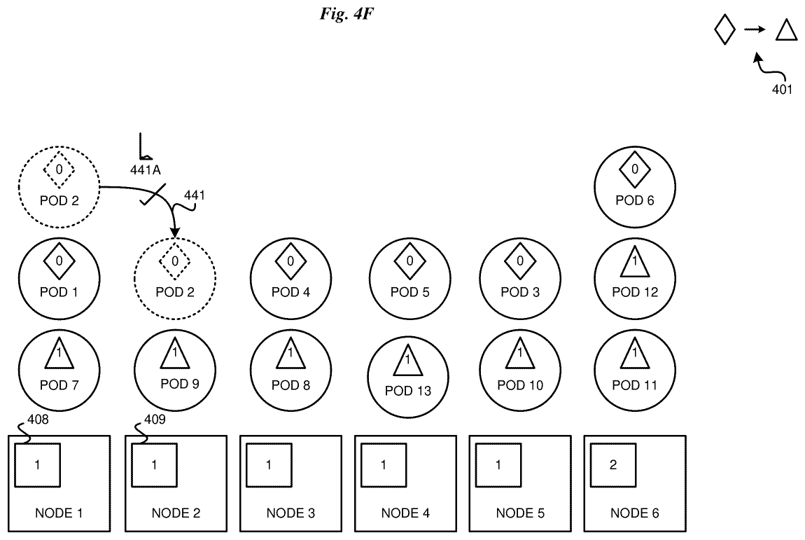

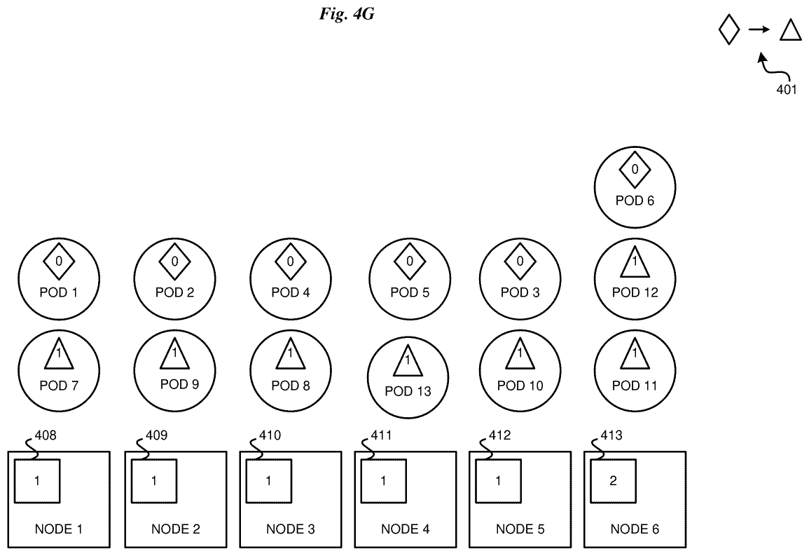

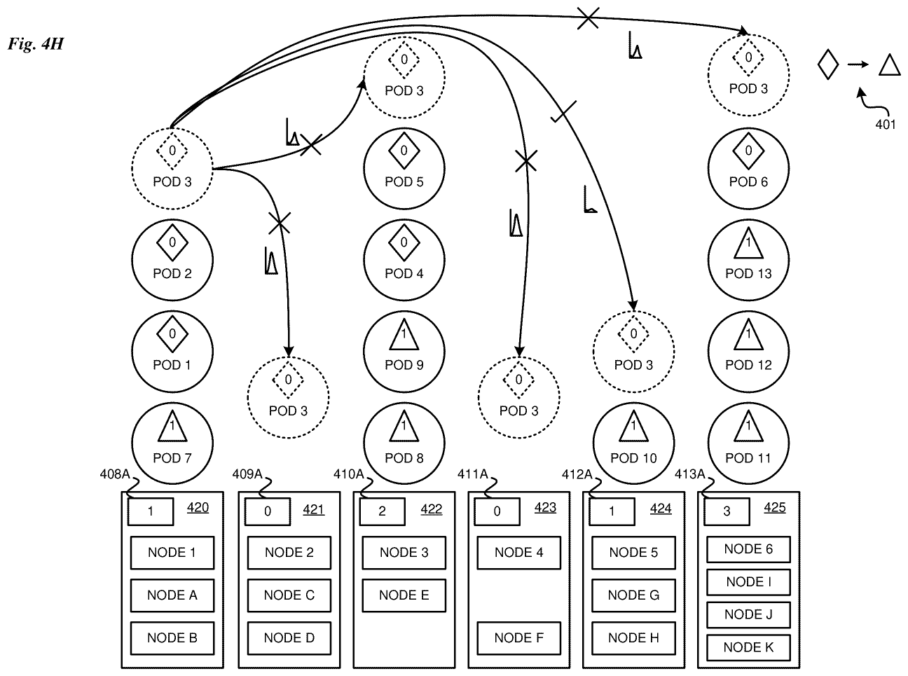

With reference to FIG. 4A, this figure depicts a step in a placement operation with an intergroup affinity constraint in accordance with an illustrative embodiment. Constraint 401 represent affinity between a group of pods identified with group 0 (402) and another group of pods identified with group 1 (404).

Pods 1-13 are improved consumers in accordance with an illustrative embodiment. Pods 1-6 are of group 0 and pods 7-13 are of group 1 in the depicted example. In the manner of an example embodiment described herein, a pod of group 0 can only be placed where a pod of group 1 already exists and based on the pricing, and a pod of group 1 can be placed anywhere based on the pricing.

Nodes 1-6 are improved providers in accordance with an illustrative embodiment. Each node in nodes 1-6 maintains an inventory (406) of group-commodity of group 1 and a count 408 of the group-commodities sold on that node at any given time. E.g., Node 1 maintains count 408, Node 2 maintains count 409, Node 3 maintains count 410, Node 4 maintains count 411, Node 5 maintains count 412, and Node 6 maintains count 413.

Depicted is an arbitrary initial configuration of consumers and providers. For the purposes of the operations illustrated in FIGS. 4A-H, assume that this initial configuration is somehow reached in a data processing environment. In the configuration shown, node 1 shows one pod of group 1 (Pod 7) being present thereon, and accordingly shows a number of 1 in count 408. Other nodes depict the numbers in their counts accordingly. This configuration has to now be redistributed across the available nodes while respecting the intergroup affinity of the pod groups.

With reference to FIG. 4B, this figure depicts another step in a placement operation with an intergroup affinity constraint in accordance with an illustrative embodiment. An embodiment, e.g., as implemented in solver 302 of FIG. 3, determines the best price move for Pod 3 of group 0 off of Node 1 to some other node. The embodiment simulates a move from a present node to a contemplated node to determine the price of such a move using the pricing function. For each simulated move, e.g., moves 431, 432, 433, 434, and 435, the embodiment computes a price—high, low, or medium—as depicted by a price graph representation depicted corresponding to each simulated move, to wit, price 431A corresponding to simulated move 431, 432A corresponding to simulated move 432, 433A corresponding to simulated move 433, 434A corresponding to simulated move 434, and 435A corresponding to simulated move 435. From the simulations, in the depicted example, the embodiment determines that price 431A is high, 432A is medium, 433A is high, 434A is low, and 435A is high under the present conditions in the data processing environment. In some cases, as in the case depicted in this figure, the embodiment may simulate all possible placements before selecting one placement. In some other cases, as in some depictions in some figures herein, the embodiment may stop further simulation once a low cost placement is found. Furthermore, if more than one low cost placement possibilities are discovered, an embodiment may select the first found low cost placement, or apply some other method of selecting between two low cost placements within the scope of the illustrative embodiments.

Accordingly, the embodiment rejects moves 431, 432, 433, and 435, and chooses to move Pod 3 to Node 5 according to move 434. Because Pod 3 is of group 0, count 408 of sold group-commodity at Node 1 and count 412 at Node 5 do not change.

With reference to FIG. 4C, this figure depicts another step in a placement operation with an intergroup affinity constraint in accordance with an illustrative embodiment. Continuing from FIG. 4B, the embodiment next determines the best price move for Pod 13 of group 1 off of Node 6 to some other node. The embodiment simulates moves 436 and 437, and computes price 436A corresponding to simulated move 436 and 437A corresponding to simulated move 437. From the simulations, in the depicted example, the embodiment determines that price 436A is medium and 437A is low. Having found a low price already, the embodiment foregoes further move simulations and chooses to move Pod 13 to Node 4 according to move 437. Because Pod 13 is of group 1, the counts 413 and 411 of sold group-commodity at Node 6 and Node 4, respectively, change to reflect one less group-commodity sold at Node 6 and one more group-commodity sold at Node 4. The count 412 at Node 5 is simulated to show one more sold group-commodity during move 436 simulation but is reset to the previous value when move 436 is rejected and move 437 is confirmed.

With reference to FIG. 4D, this figure depicts another step in a placement operation with an intergroup affinity constraint in accordance with an illustrative embodiment. Continuing from FIG. 4C, the embodiment next determines the best price move for Pod 5 of group 0 off of Node 3 to some other node. The embodiment simulates moves 438 and 439, and computes price 438A corresponding to simulated move 438 and 439A corresponding to simulated move 439. From the simulations, in the depicted example, the embodiment determines that price 438A is high and 439A is low. Having found a low price already, the embodiment foregoes further move simulations and chooses to move Pod 5 to Node 4 according to move 439. Because Pod 5 is of group 0, the counts 409, 410, and 411 of sold group-commodity at Nodes 2, 3, and 4, respectively, do not change.

With reference to FIG. 4E, this figure depicts another step in a placement operation with an intergroup affinity constraint in accordance with an illustrative embodiment. Continuing from FIG. 4D, the embodiment next determines the best price move for Pod 9 of group 1 off of Node 3 to some other node. The embodiment simulates move 440 and computes price 440A corresponding to simulated move 440. From the simulations, in the depicted example, the embodiment determines that price 440A is low. Having found a low price already, the embodiment foregoes further move simulations and chooses to move Pod 9 to Node 2 according to move 440. Because Pod 9 is of group 1, the counts 409 and 410 of sold group-commodity at Node 2 and Node 3, respectively, change to reflect one less group-commodity sold at Node 3 and one more group-commodity sold at Node 2.

With reference to FIG. 4F, this figure depicts another step in a placement operation with an intergroup affinity constraint in accordance with an illustrative embodiment. Continuing from FIG. 4E, the embodiment next determines the best price move for Pod 2 of group 0 off of Node 1 to some other node. The embodiment simulates move 441 and computes price 441A corresponding to simulated move 441. From the simulations, in the depicted example, the embodiment determines that price 441A is low. Having found a low price already, the embodiment foregoes further move simulations and chooses to move Pod 2 to Node 2 according to move 441. Because Pod 2 is of group 0, the counts 408 and 409 of sold group-commodity at Nodes 1 and 2, respectively, do not change.

With reference to FIG. 4G, this figure depicts another step in a placement operation with an intergroup affinity constraint in accordance with an illustrative embodiment. This figure depicts a configuration where a desired final state of the pods placement on nodes has been reached in the example data processing environment, as reflected by counts 408-413. The embodiment stops further placement simulations.

With reference to FIG. 4H, this figure depicts a placement operation with an intergroup affinity constraint relative to partitions of providers in accordance with an illustrative embodiment. the example configuration in FIG. 4H is similar to the example configuration depicted in FIG. 4A, except that instead of singular nodes—Nodes 1-6 in FIG. 4A—taking on pod placements, FIG. 4H depicts partitions of providers being used to perform pod placements. For example, partition 420 comprises a number of nodes, including Node 1 without implying any limitation thereto, and maintains count 408A of group-commodities sold in partition 420. Similarly, partition 421 comprises a number of nodes, including Node 2 without implying any limitation thereto, and maintains count 409A of group-commodities sold in partition 421; partition 422 comprises a number of nodes, including Node 3 without implying any limitation thereto, and maintains count 410A of group-commodities sold in partition 422; partition 423 comprises a number of nodes, including Node 4 without implying any limitation thereto, and maintains count 411A of group-commodities sold in partition 423; partition 424 comprises a number of nodes, including Node 5 without implying any limitation thereto, and maintains count 412A of group-commodities sold in partition 424; and partition 425 comprises a number of nodes, including Node 6 without implying any limitation thereto, and maintains count 413A of group-commodities sold in partition 425.

An embodiment, e.g., as implemented in solver 302 of FIG. 3, can perform pod placement steps relative to partitions 420-425 in a manner similar to the steps depicted in FIGS. 4B-4G relative to Nodes 1-6. Counts 408A-413A relative to partitions 420-425, respectively, are managed in a manner similar to counts 408-413 relative to Nodes 1-6, respectively. Thus, the embodiment is able to perform computationally efficient consumer placement on partitions of providers while enforcing the intergroup affinity constraint between groups of consumers.

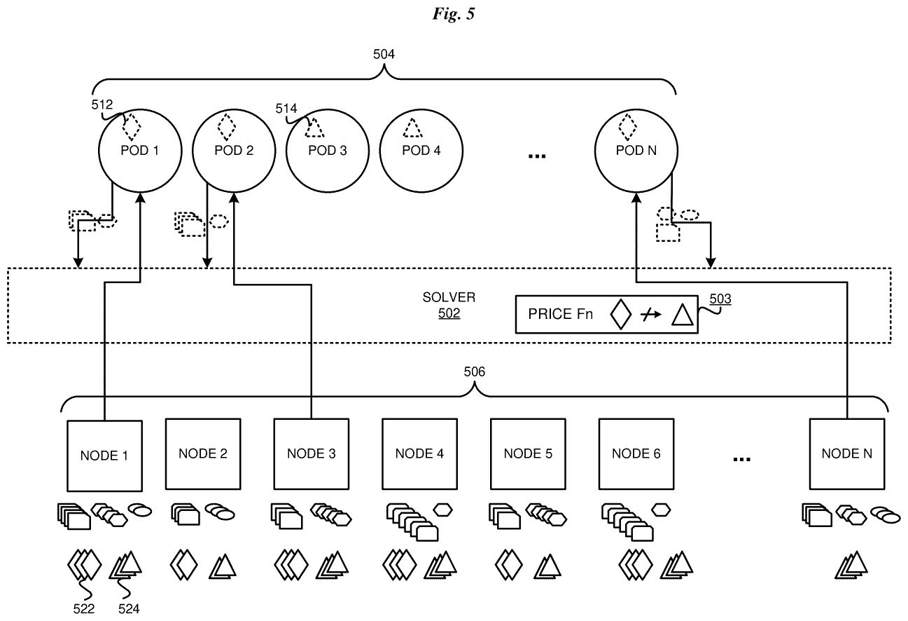

With reference to FIG. 5, this figure depicts a configuration for efficient placement of virtualized instances with intergroup affinity and anti-affinity in accordance with an illustrative embodiment. Application 502 is an example of application 200 in FIG. 1. Application 502 is an improved solver as described herein, implementing one or more pricing functions according to one or more embodiments described herein. In the depiction of FIG. 5, solver 502 implements an intergroup anti-affinity pricing function 503 as described herein.

Pods 504, identified as Pod 1, Pod 2, Pod 3, Pod 4, . . . , Pod n, represent a plurality of improved consumers as described herein. Nodes 506, identified as Node 1, Node 2, Node 3, Node 4, Node 5, Node 6, . . . , Node n, represent a plurality of improved providers as described herein.

For example, each of pods 504 implements a way of requesting, or buying, a group-commodity corresponding to a group or consumer group associated with the pod. Different shapes of group-commodities represent different groups and are selected arbitrarily for illustration purposes. For example, Pod 1 is of group 512, illustrated as a diamond shape, and Pod 3 is of group 514, illustrated as a triangle shape. Similarly, each of nodes 506 implements a group-commodity corresponding to a group or consumer group associated with the pods and the node maintains a quantity of the group-commodities of one or more groups that it can allocate, or sell, in response to a request from a pod. For example, Node 1 is shown to maintain a certain quantity 522 of group-commodity of group 512, and a certain quantity 524 of group-commodity of group 514. Other nodes in nodes 506 are similarly configured.

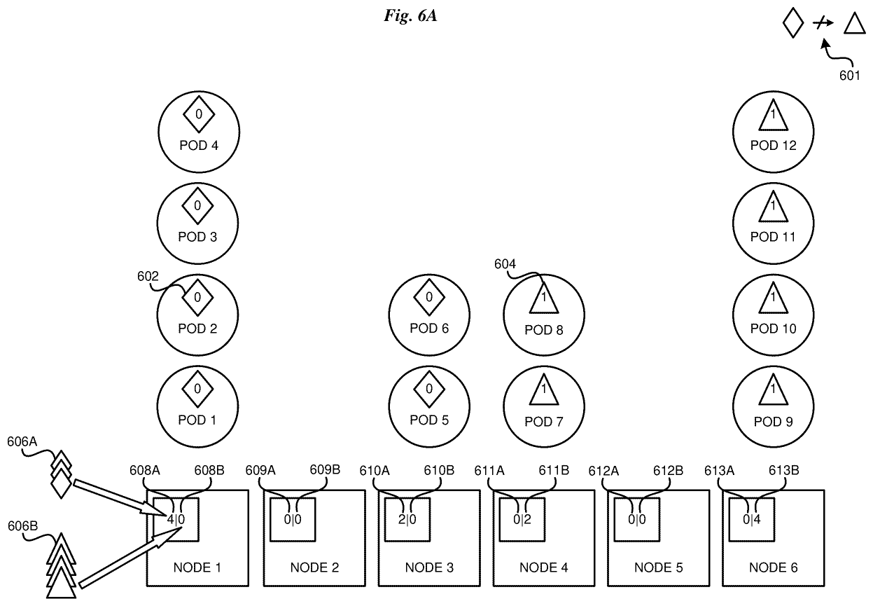

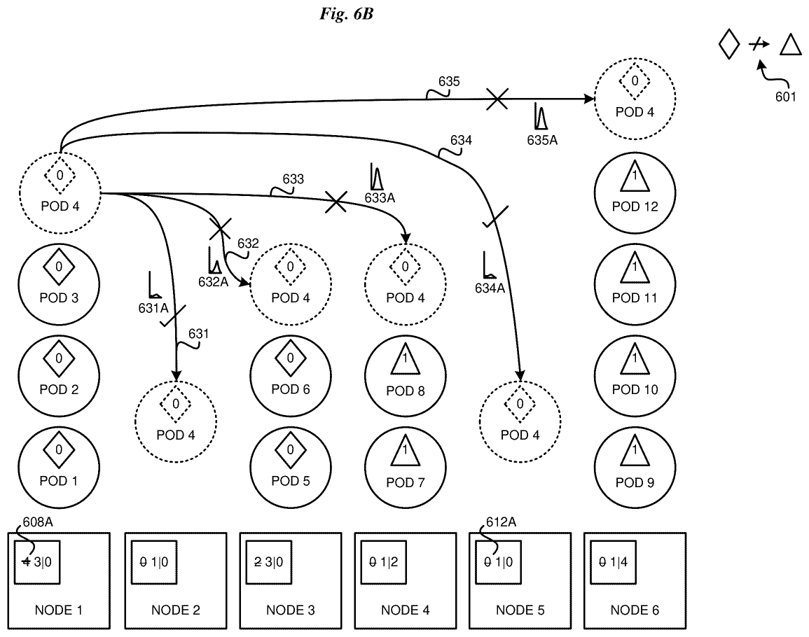

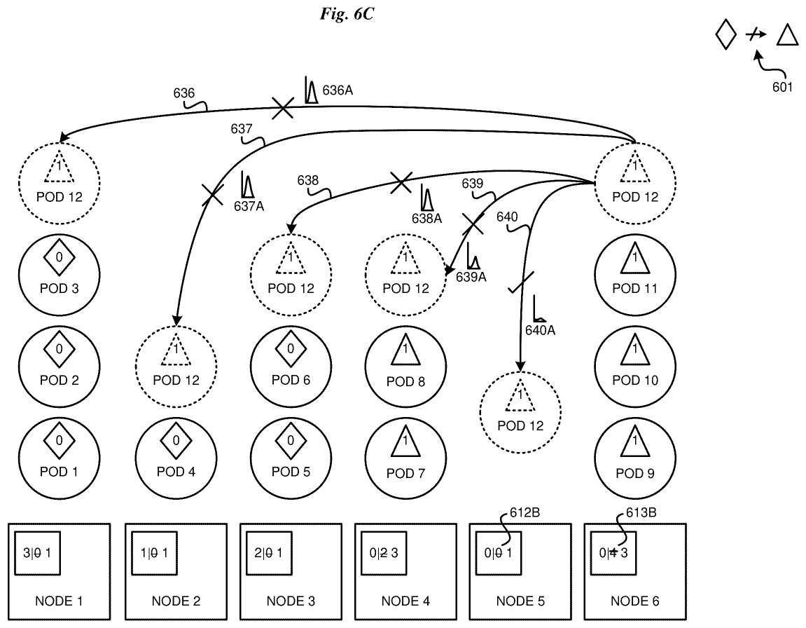

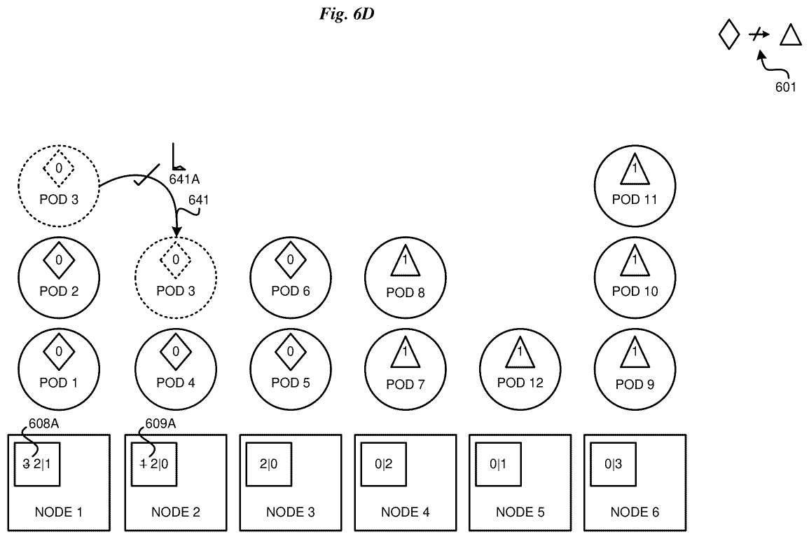

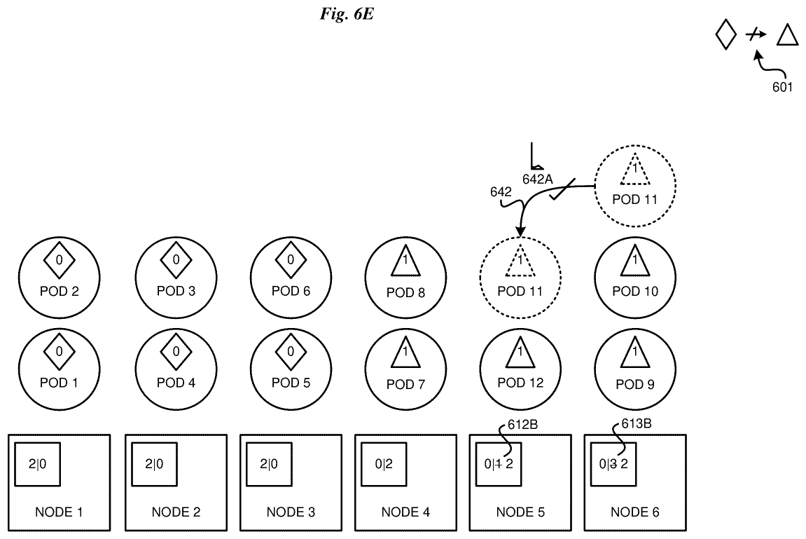

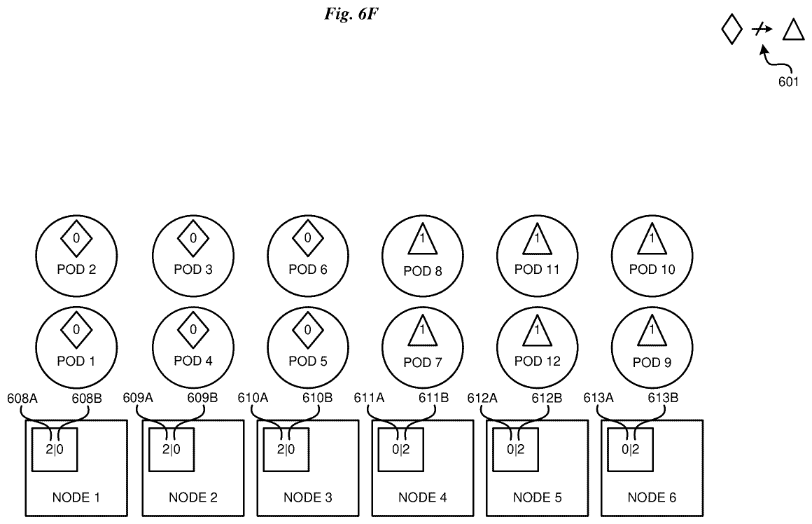

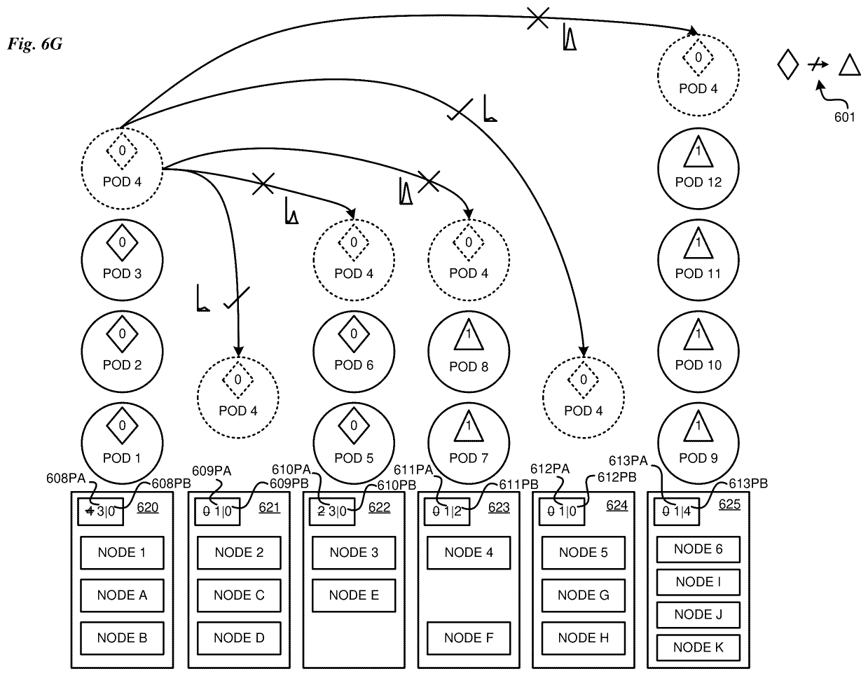

With reference to FIG. 6A, this figure depicts a step in a placement operation with an intergroup anti-affinity constraint in accordance with an illustrative embodiment. Constraint 601 represent anti-affinity between a group of pods identified with group 0 (602) and another group of pods identified with group 1 (604).

Pods 1-12 are improved consumers in accordance with an illustrative embodiment. Pods 1-6 are of group 0 and pods 7-12 are of group 1 in the depicted example. In the manner of an example embodiment described herein, a pod of group 0 cannot be placed where a pod of group 1 already exists and based on the pricing, and a pod of group 1 cannot be placed where a pod of group 0 exists and based on the pricing.

Nodes 1-6 are improved providers in accordance with an illustrative embodiment. Each node in nodes 1-6 maintains an inventory count (606A) of group-commodity of group 0, an inventory count (606B) of group-commodity of group 1, and a count of the groups of group-commodities sold on that node at any given time. Specifically—count 608A tracks the sold count of group-commodities of group 0 and count 608B tracks the sold count of group-commodities of group 1. In a similar manner, Node 2 maintains count 609A for group-commodities of group 0 sold at Node 2 and count 609B for group-commodities of group 1 sold at Node 2; Node 3 maintains count 610A for group-commodities of group 0 sold at Node 3 and count 610B for group-commodities of group 1 sold at Node 3; Node 4 maintains count 611A for group-commodities of group 0 sold at Node 4 and count 611B for group-commodities of group 1 sold at Node 4; Node 5 maintains count 612A for group-commodities of group 0 sold at Node 5 and count 612B for group-commodities of group 1 sold at Node 5; and Node 6 maintains count 613A for group-commodities of group 0 sold at Node 6 and count 613B for group-commodities of group 1 sold at Node 6.

Depicted is an arbitrary initial configuration of consumers and providers. For the purposes of the operations illustrated in FIGS. 6A-G, assume that this initial configuration is somehow reached in a data processing environment. In the configuration shown, node 1 shows four pods of group 0 (Pods 1-4) being present thereon, and accordingly shows a number of 4 in count 608A, and no pods of group 1 being present thereon, and accordingly shows a number of 0 in count 608B. Other nodes depict the numbers in their counts accordingly. This configuration has to now be redistributed across the available nodes while respecting the intergroup anti-affinity of the pod groups.

With reference to FIG. 6B, this figure depicts another step in a placement operation with an intergroup anti-affinity constraint in accordance with an illustrative embodiment. An embodiment, e.g., as implemented in solver 302 of FIG. 5, determines the best price move for Pod 4 of group 0 off of Node 1 to some other node. The embodiment simulates a move from a present node to a contemplated node to determine the price of such a move using the pricing function. For each simulated move, e.g., moves 631, 632, 633, 634, and 635, the embodiment computes a price—high, low, or medium—as depicted by a price graph representation depicted corresponding to each simulated move, to wit, price 631A corresponding to simulated move 631, 632A corresponding to simulated move 632, 633A corresponding to simulated move 633, 634A corresponding to simulated move 634, and 635A corresponding to simulated move 635. From the simulations, in the depicted example, the embodiment determines that price 631A is low, 632A is medium, 633A is high, 634A is low, and 635A is high under the present conditions in the data processing environment. In some cases, as in the case depicted in this figure, the embodiment may simulate all possible placements before selecting one placement. In some other cases, as in some depictions in some figures herein, the embodiment may stop further simulation once a low cost placement is found. Furthermore, if more than one low cost placement possibilities are discovered, an embodiment may select the first found low cost placement, or apply some other method of selecting between two low cost placements within the scope of the illustrative embodiments.

Accordingly, the embodiment rejects moves 632, 633, 634, and 635, and chooses to move Pod 4 to Node 2—the first found low cost placement-according to move 631. Because Pod 4 is of group 0, count 608A of sold group-commodity at Node 1 is reduced by one and count 609A at Node 2 is increased by one. The counts at Nodes 3-6 are simulated to show one more sold group-commodity of group 0 during the simulation but are reset to the respective previous values when moves 632-635 are rejected and move 631 is confirmed.

With reference to FIG. 6C, this figure depicts another step in a placement operation with an intergroup anti-affinity constraint in accordance with an illustrative embodiment. Continuing from FIG. 6B, the embodiment next determines the best price move for Pod 12 of group 1 off of Node 6 to some other node. The embodiment simulates moves 636 with price 636A, 637 with price 637A, 638 with price 638A, 639 with price 639A, and 640 with price 640A. From the simulations, in the depicted example, the embodiment determines that price 640A is low and all the other prices are either medium or high. The embodiment chooses to move Pod 12 to Node 5 according to move 640. Because Pod 12 is of group 1, the counts 612B and 613B of sold group-commodity at Node 5 and Node 6, respectively, change to reflect one more group-commodity of group 1 sold at Node 5 and one less group-commodity of group 1 sold at Node 6. The counts at Nodes 1-4 are simulated to show one more sold group-commodity of group 1 during the simulation but are reset to the respective previous values when moves 636-639 are rejected and move 640 is confirmed.

With reference to FIG. 6D, this figure depicts another step in a placement operation with an intergroup anti-affinity constraint in accordance with an illustrative embodiment. The embodiment determines the best price move for Pod 3 of group 0 off of Node 1 to some other node. The embodiment simulates move 641 and computes the corresponding price 641A as a low price, or some price other than a high price that would prevent placement. Having found a low price already, the embodiment foregoes further move simulations and chooses to move Pod 3 to Node 2 according to move 641. Because Pod 3 is of group 0, the counts 608A and 609A of sold group-commodity at Node 1 and Node 2, respectively, change to reflect one more group-commodity of group 0 sold at Node 2 and one less group-commodity of group 0 sold at Node 1.

With reference to FIG. 6E, this figure depicts another step in a placement operation with an intergroup anti-affinity constraint in accordance with an illustrative embodiment. The embodiment determines the best price move for Pod 11 of group 1 off of Node 6 to some other node. The embodiment simulates move 642 and computes the corresponding price 642A as a low price. Having found a low price already, the embodiment foregoes further move simulations and chooses to move Pod 11 to Node 5 according to move 642. Because Pod 11 is of group 1, the counts 612B and 613B of sold group-commodity at Node 5 and Node 6, respectively, change to reflect one more group-commodity of group 1 sold at Node 5 and one less group-commodity of group 1 sold at Node 6.

With reference to FIG. 6F, this figure depicts another step in a placement operation with an intergroup anti-affinity constraint in accordance with an illustrative embodiment. This figure depicts a configuration where a desired final state of the pods placement on nodes has been reached in the example data processing environment, as reflected by counts 608A-B through 613A-B. The embodiment stops further placement simulations.

With reference to FIG. 6G, this figure depicts a placement operation with an intergroup anti-affinity constraint relative to partitions of providers in accordance with an illustrative embodiment. the example configuration in FIG. 6G is similar to the example configuration depicted in FIG. 6A, except that instead of singular nodes—Nodes 1-6 in FIG. 6A—taking on pod placements, FIG. 6G depicts partitions of providers being used to perform pod placements. For example, partition 620 comprises a number of nodes, including Node 1 without implying any limitation thereto, and maintains count 608PA of group-commodities of group 0 sold in partition 620 and count 608PB of group-commodities of group 1 sold in partition 620. Similarly, partition 621 comprises a number of nodes, including Node 2 without implying any limitation thereto, and maintains count 609PA of group-commodities of group 0 sold in partition 621 and count 609PB of group-commodities of group 1 sold in partition 621; partition 622 comprises a number of nodes, including Node 3 without implying any limitation thereto, and maintains count 610PA of group-commodities of group 0 sold in partition 622 and count 610PB of group-commodities of group 1 sold in partition 622; partition 623 comprises a number of nodes, including Node 4 without implying any limitation thereto, and maintains count 611PA of group-commodities of group 0 sold in partition 623 and count 611PB of group-commodities of group 1 sold in partition 623; partition 624 comprises a number of nodes, including Node 5 without implying any limitation thereto, and maintains count 612PA of group-commodities of group 0 sold in partition 624 and count 612PB of group-commodities of group 1 sold in partition 624; and partition 625 comprises a number of nodes, including Node 6 without implying any limitation thereto, and maintains count 613PA of group-commodities of group 0 sold in partition 625 and count 613PB of group-commodities of group 1 sold in partition 625.

An embodiment, e.g., as implemented in solver 302 of FIG. 3, can perform pod placement steps relative to partitions 620-625 in a manner similar to the steps depicted in FIGS. 6B-6F relative to Nodes 1-6. Counts 608PA-PB through 613PA-PB relative to partitions 620-625, respectively, are managed in a manner similar to counts 608A-B through 613A-B relative to Nodes 1-6, respectively. Thus, the embodiment is able to perform computationally efficient consumer placement on partitions of providers while enforcing the intergroup anti-affinity constraint between groups of consumers.

The following definitions and abbreviations are to be used for the interpretation of the claims and the specification. As used herein, the terms “comprises,” “comprising,” “includes,” “including,” “has,” “having,” “contains,” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.” References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

What is claimed is:

1. A computer-implemented method comprising:
configuring, in a solver component in a data processing environment comprising a set of consumer pods (consumers) and a set of provider nodes (providers), a pricing function, wherein the set of consumers comprises a first subset of a first group of consumers and a second subset of a second group of consumers;
further configuring, in the pricing function an intergroup affinity between the first subset and the second subset of consumers;
configuring the intergroup affinity such that a member of the first subset of consumers gets placed on a selected provider from the set of providers when the selected provider already hosts a member of the second subset of consumers; and
causing, by the solver component responsive to the configuring of the intergroup affinity, a first placement of a first consumer from the first subset at a first provider from the set of providers, the first provider already hosting a first consumer from the second subset of consumers.

2. The computer-implemented method of claim 1, further comprising:
computing, by the solver component using the pricing function, a price for the first placement;
computing, by the solver component using the pricing function, a second price for a second placement of the first consumer from the first subset of consumers on a second provider from the set of providers; and
performing the first placement responsive to the second price being higher than the second price.

3. The computer-implemented method of claim 2, wherein the pricing function results in the second price being higher than the first price because no member of the second subset of consumers is hosted on the second provider from the set of providers.

4. The computer-implemented method of claim 2, wherein the pricing function results in the second price being higher than the first price because at least one other member of the first subset of consumers and at least one member of the second subset of consumers is hosted on the second provider from the set of providers.

5. The computer-implemented method of claim 1, further comprising:
causing, by the solver component, a second placement of the first consumer from the second subset of consumers on the first provider from the set of providers.

6. The computer-implemented method of claim 5, wherein the second placement is caused regardless of a price of the second placement.

7. The computer-implemented method of claim 5, further comprising:
computing, by the solver component using the pricing function, a price for the second placement;
computing, by the solver component using the pricing function, a second price for a third placement of the first consumer from the second subset of consumers on a second provider from the set of providers; and
performing the second placement responsive to the price being lower than the second price.

8. The computer-implemented method of claim 1, wherein at least one provider in the set of providers is configured with a corresponding count, wherein the count in a provider is indicative of a number of consumers from the second subset of consumers that are hosted on the provider, and
wherein the solver component uses a first count of the first provider in the pricing function to cause the first placement.

9. The computer-implemented method of claim 8, wherein the first placement is responsive to the first count being higher than a second count of a second provider in the set of providers.

10. The computer-implemented method of claim 1, wherein at least one consumer in the set of consumers is configured with a corresponding group code,
wherein the first group of consumers have a first group code and the second group of consumers have a second group code,
wherein the intergroup affinity of the pricing function causes a first price of placement of a consumer of the first group together with a consumer of the second group to be below a threshold, and
wherein the intergroup affinity of the pricing function causes a second price of placement of a consumer of the first group at a specific provider without a consumer of the second group being present at the specific provider to be above a threshold.

11. The computer-implemented method of claim 1, further comprising:
configuring, in
the solver component a second pricing function, the second pricing function comprising an intergroup anti-affinity between a third subset and a fourth subset of consumers;
configuring the intergroup anti-affinity such that a member of the third subset of consumers cannot be placed on a selected provider from the set of providers when the selected provider already hosts a member of the fourth subset of consumers; and
causing, by the solver component responsive to the configuring of the intergroup affinity, a third placement of a third consumer from the third subset at a third provider from the set of providers, the third provider not hosting any consumer from the fourth subset of consumers.

12. The computer-implemented method of claim 11, further comprising:
computing, by the solver component using the second pricing function, a price for the third placement;
computing, by the solver component using the second pricing function, a fourth price for a fourth placement of the third consumer from the third subset of consumers on a fourth provider from the set of providers; and
performing the third placement responsive to the fourth price being higher than the third price.

13. The computer-implemented method of claim 12, wherein the second pricing function results in the fourth price being higher than the third price because a member of the fourth subset of consumers is hosted on the fourth provider from the set of providers.

14. The computer-implemented method of claim 12, wherein the second pricing function results in the fourth price being higher than the third price because at least one other member of the third subset of consumers is hosted on the fourth provider from the set of providers.

15. The computer-implemented method of claim 11, further comprising:
avoiding, by the solver component, and subsequent to the third placement, a fourth placement of a fifth consumer from the fourth subset of consumers on the third provider from the set of providers.

16. The computer-implemented method of claim 11, wherein at least one provider in the set of providers is further configured with a corresponding count A and count B, wherein the count A in a provider is indicative of a number of consumers from the third subset of consumers that are hosted on the provider, and the count B in the provider is indicative of a number of consumers from the fourth subset of consumers that are hosted on the provider, and
wherein the solver component uses a count B of the third provider in the second pricing function to cause the third placement.

17. A computer program product comprising:
one or more computer readable storage media; and
program instructions stored on the one or more storage media and configured to perform operations comprising:
configuring, in a solver component in a data processing environment comprising a set of consumer pods (consumers) and a set of provider nodes (providers), a pricing function, wherein the set of consumers comprises a first subset of a first group of consumers and a second subset of a second group of consumers;
further configuring, in the pricing function an intergroup affinity between the first subset and the second subset of consumers;
configuring the intergroup affinity such that a member of the first subset of consumers gets placed on a selected provider from the set of providers when the selected provider already hosts a member of the second subset of consumers; and
causing, by the solver component responsive to the configuring of the intergroup affinity, a first placement of a first consumer from the first subset at a first provider from the set of providers, the first provider already hosting a first consumer from the second subset of consumers.

18. The computer program product of claim 17, wherein the stored program instructions are stored in a computer readable storage device in a data processing system, and wherein the stored program instructions are transferred over a network from a remote data processing system.

19. The computer program product of claim 17, wherein the stored program instructions are stored in a computer readable storage device in a server data processing system, and wherein the stored program instructions are downloaded in response to a request over a network to a remote data processing system for use in a computer readable storage device associated with the remote data processing system, further comprising:
program instructions to meter use of the program instructions associated with the request; and
program instructions to generate an invoice based on the metered use.

20. A computer system comprising a processor and one or more computer readable storage media, and program instructions collectively stored on the one or more computer readable storage media, the program instructions executable by the processor to cause the processor to perform operations comprising:
configuring, in a solver component in a data processing environment comprising a set of consumer pods (consumers) and a set of provider nodes (providers), a pricing function, wherein the set of consumers comprises a first subset of a first group of consumers and a second subset of a second group of consumers;
further configuring, in the pricing function an intergroup affinity between the first subset and the second subset of consumers;
configuring the intergroup affinity such that a member of the first subset of consumers gets placed on a selected provider from the set of providers when the selected provider already hosts a member of the second subset of consumers; and
causing, by the solver component responsive to the configuring of the intergroup affinity, a first placement of a first consumer from the first subset at a first provider from the set of providers, the first provider already hosting a first consumer from the second subset of consumers.
